(19) United States
(12) Patent Application Publication
(10) Pub. No.: US 2025/0384434 A1
(43) Pub. Date: Dec. 18, 2025

(54) Systems and Methods to Securely Transfer Digital Tokens

(71) Applicant: Ramsee 1 LLC, New York, NY (US)

(72) Inventors: Alan RECHTSCHAFFEN, New York, NY (US); Miera RECHTSCHAFFEN, New York, NY (US)

(21) Appl. No.: 19/239,341

(22) Filed: Jun. 16, 2025

Related U.S. Application Data
(60) Provisional application No. 63/660,118, filed on Jun. 14, 2024.

(51) Int. Cl. G06Q 20/38; G06Q 30/0208

(52) U.S. Cl. CPC G06Q 20/3821; G06Q 30/0208

(57) ABSTRACT

A system configured to receive, from a first user, a digital currency unit comprising an indication of a loyalty status associated with the digital currency unit, wherein the digital currency unit is associated with one or more blocks of a distributed ledger, wherein the one or more blocks record the indication of the loyalty status and a transferability indication corresponding to the digital currency unit, determine the digital currency unit was transferred to the first user from a second user, verify, based on information recorded on the one or more blocks, that the digital currency unit is transferable and, in response to verifying the digital currency unit is transferable, send a response to the first user including the indication of the loyalty status associated with the digital currency unit.

### PRIORITY/INCORPORATION BY REFERENCE

This application claims priority to U.S. Provisional Application Ser. No. 63/660,118 filed on Jun. 14, 2024, and entitled “Systems and Methods to Securely Transfer Digital Tokens,” the entirety of which is incorporated by reference herein.

### BACKGROUND

Customer loyalty programs are used widely across many different retail environments, e.g., grocery stores, department stores, luxury goods stores, airlines, etc. These customer loyalty programs may allow the retailer (or other entity) to provide benefits to customers such as access to exclusive discounts, exclusive products, etc. to which only members of the customer loyalty program have access. This access may depend on a status of the customers, e.g., silver status, gold status, platinum status, etc.

Customer loyalty programs have an inherent problem in that a customer may not transfer a status to another person. For example, in some customer loyalty programs, a first customer may transfer rewards (e.g., points, miles, etc.) to a second customer. However, the status associated with those rewards are not transferred to the second customer. The second customer may merely use the reward but is not entitled to any benefits of the status attained by the first customer. In addition, the transfer of the rewards is a cumbersome process that typically requires human intervention on the part of the issuer of the rewards to verify that the first customer has the right to transfer the rewards to the second customer and that the second customer is eligible to receive the reward. These drawbacks lead to a bad user experience for the customers and may prevent the issuer from gaining the advantages of allowing status to be transferred, e.g., obtaining new customers, etc.

### SUMMARY

Some example embodiments are related to a system having a memory and a processor communicatively coupled to the memory and configured to receive, from a first user, a digital currency unit comprising an indication of a loyalty status associated with the digital currency unit, wherein the digital currency unit is associated with one or more blocks of a distributed ledger, wherein the one or more blocks record the indication of the loyalty status and a transferability indication corresponding to the digital currency unit, determine the digital currency unit was transferred to the first user from a second user; verify, based on information recorded on the one or more blocks, that the digital currency unit is transferable and, in response to verifying the digital currency unit is transferable, send a response to the first user including the indication of the loyalty status associated with the digital currency unit.

Other example embodiments are related to a system having a memory and a processor communicatively coupled to the memory and configured to receive receive, from a first user, a digital currency unit comprising an indication of a loyalty status associated with the digital currency unit, wherein the digital currency unit is associated with one or more blocks of a distributed ledger, wherein the one or more blocks record the indication of the loyalty status corresponding to the digital currency unit and a transferability indication or an identification of the digital currency unit, store the digital currency unit in a digital wallet corresponding to a second user, send, to a provider, the digital currency unit and receive, from the provider, a response including an indication of benefits associated with the loyalty status of the digital currency unit.

### BRIEF DESCRIPTION OF THE DRAWINGS

FIG. 1 is a block diagram of an example system according to various example embodiments.

FIG. 2 illustrates the distribution of the cryptocurrency to qualified customers of a customer loyalty program according to various example embodiments.

FIG. 3 illustrates a customer-to-customer loyalty status cryptocurrency transfer according to various example embodiments

FIG. 4 illustrates a flow chart showing a transfer of the cryptocurrency among customers and subsequent use to access goods or services from a provider according to various example embodiments.

FIG. 5 is a block diagram of a special purpose computer system on which various functions discussed herein may be practiced according to various example embodiments.

### DETAILED DESCRIPTION

The example embodiments may be further understood with reference to the following description and the related appended drawings, wherein like elements are provided with the same reference numerals. The example embodiments relate to using cryptocurrency tokens in a customer loyalty program for the purpose of allowing the customer to transfer a loyalty status to a third party without human intervention or verification by an issuer of the cryptocurrency tokens.

Cryptocurrency may be a digital asset that operates in the same manner as fiat currency, e.g., cryptocurrency may represent value that may be used to acquire goods and services. The cryptocurrency may be an open ecosystem entity such as bitcoin that may be accepted by multiple entities that sell goods or services. The cryptocurrency may also be a closed ecosystem, e.g., a larger retailer may issue a cryptocurrency that may only be exchanged for goods and services at the retailer. There may also be hybrid cryptocurrencies that are somewhere between a fully open ecosystem and a closed ecosystem.

The example embodiments are described with reference to an example cryptocurrency where record keepers generate hash values when a transaction occurs and if approved a “block” is created to add to a distributed ledger that may be used to validate exchanges and/or other operations. A blockchain is a chain of these entries and is, in essence, the ledger itself. The blockchain is supported across multiple computers (nodes) that are linked in a peer-to-peer network. Blockchain technology is designed to solve the “trust problem.” It creates a verifiable ledger that no one node may compromise. It is transparent, time-stamped and decentralized. The example embodiments make use of the blockchain technology to solve the issues related to transferability of status for the example cryptocurrency. In the example embodiments, a digital unit, unit or units of the cryptocurrency may be referred to as “tokens” or “coins.” Thus, throughout this description, the terms cryptocurrency, units, tokens or coins may be used interchangeably.

The following provides a description of an example cryptocurrency that may be used to implement the example embodiments. However, it should be understood that the example embodiments are not limited to use with the described cryptocurrency, e.g., those skilled in the art will understand how to apply the example embodiments to any cryptocurrency scheme.

There may be various manners for cryptocurrencies to use blockchain technology to encrypt the cryptocurrency. For example, in some blockchain technologies, the data associated with a new transaction becomes a new block. This block has a cryptographic hash that includes information that may link the block to the most recent block in the blockchain, a time of the transaction, and a record of transaction information. The blocks of a blockchain may link in chronological order and be recorded in a distributed ledger. Each coin or token of the cryptocurrency may include this blockchain information that uniquely identifies the coin or token. In the example embodiments, the blocks may be extended to include information related to the example customer loyalty program. For example, this information may include the status of the customer in a customer loyalty program (e.g., gold status, silver status, etc.), an identification of a benefit to which the holder of the coin is entitled, etc. Some examples of the benefits are described in various use cases provided below. In another example, this information n may include a transferability indication, e.g., is the coin or token allowed to be transferred to another user or customer. Throughout this description, the status level is described using a precious metal analogy, e.g., silver, gold, platinum. However, this is only an example and retailers may use any analogy and any number of loyalty status levels, e.g., star ratings, level 1, 2, 3, etc., rated/non-rated, etc.

There is no current solution to solve the transferability issue of status because the benefits associated with the status are tied to a specific user account. Thus, at the user level, there is no manner of transferring these benefits (either in whole or in part) to a different user account. At the retailer level, there is no manner of recording and verifying the transfers of benefits.

The example embodiments provide a specific blockchain architecture that embeds transferability indicators, multi-user provenance tracking, and loyalty status metadata directly into the distributed ledger blocks-creating a technically improved blockchain that solves the technical problem of status verification without centralized authority. This allows for real-time technical verification of transfer eligibility by parsing blockchain-embedded transferability rules, eliminating the technical bottleneck of human verification systems. Unlike traditional systems that cryptographically tie status to specific user accounts, the example embodiments create a technically superior architecture where possession of the properly formatted token is the verification mechanism. The example embodiments implementing these features are described in greater detail below.

The example embodiments allow the cryptocurrency token to act as a definitive identifier of customer status. In the example embodiments, the cryptocurrency tokens may act as gateway tokens and/or reward tokens. A gateway token may be used to identify the loyalty status of customer, which in turn, may control access to the customer loyalty program, e.g., is this customer allowed to access the customer loyalty program and what level is the customer allowed to access. The gateway token may also allow the retailer to understand how the customer received the loyalty status, e.g., is this an original customer that earned reward status, is this a customer who was transferred loyalty status, who transferred the loyalty status to this customer, etc. All this information may be securely recorded on the blockchain of the gateway token.

Reward token(s) may be used to exchange for the benefits that are provided by the customer loyalty program, e.g., the customer may exchange a reward token for a 10% discount, each reward token is worth 1,000 frequent flyer miles that may be exchanged for free flights/services/merchandise, etc.

In the example embodiments, the gateway tokens and the reward tokens are described as separate tokens, e.g., a customer may have a gateway token that indicates the loyalty status of the customer and one or more reward tokens that may be exchanged for goods and services. However, the example embodiments are not limited to the scenario where the gateway tokens and the reward tokens are separate. There may be example embodiments where the information related to loyalty status and reward status are recorded in the same token(s), e.g., each of the customer's tokens include a recording of the loyalty status. Thus, throughout this description, whenever a gateway token and/or reward token is described, it should be understood that the tokens may be tokens with a separate functionality, e.g., loyalty or reward, or single token(s) with both functionalities.

The use of the tokens decouples the status (and associated benefits) from the user account, e.g., the simple fact that the customer has the token with the related status indicates to the provider of the goods and services that the customer is entitled to the benefits associated with the status. This also relieves the customer of having to remember/save credential information such as username and password information and also prevents this type of credential information from being stolen in an identify theft. The cryptocurrency token that is in the customer's electronic wallet acts as the identifier of the customer and the benefits to which the customer is entitled. The use of the tokens allows the retailer to easily understand that the customer is entitled to the benefits. This solves the transferability issue for both the customer and the retailer and holds potential for diverse application across multiple industries, including airlines, hotels, retailers, and restaurants. Some example use cases of the example embodiments are described in further detail below.

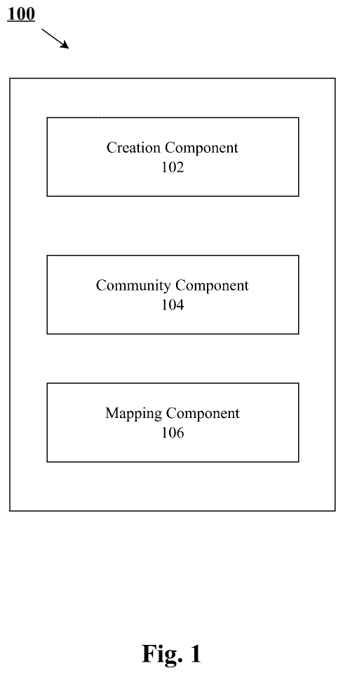

FIG. 1 is a block diagram of an example system 100 according to various example embodiments. According to various example embodiments, the system 100 may be configured to execute any of the described functions herein to instantiate specific system components tailored to execute specific functions. The system 100 may include a crypto creation component 102 that is configured to generate tokens for exchange through the system 100, e.g., gateway tokens and/or reward tokens. The tokens may be issued in limited numbers, ensuring that they remain exclusive and valuable. The tokens may be redeemable for fiat currency for the amount paid, but there is no requirement that the tokens be redeemable for cash. As described above, gateway tokens may be used to indicate a loyalty status of the customer to allow the customer access to certain benefits such as access to an inventory of exclusive items not available to other customers. These exclusive items may be priced in reward tokens which may be used to purchase the exclusive items. Some example use cases of purchasing exclusive items are described in greater detail below.

The system 100 may also include a community component 104 configured to manage registration of community members, qualification of registered users, and compliance with any community requirements. As will be described in greater detail below, access to the customer loyalty program and corresponding gateway tokens may be governed by a set of rules or criteria that allows a user to become a member (or qualified user) of the customer loyalty program. The rules may also allow for a user to transfer status via the use of the gateway tokens to another user. The community component 104 may enforce these rules or criteria and allow gateway tokens to be distributed to qualified users and/or transferred to other users.

The system 100 may also include a mapping component 106 configured to generate an encoded mapping associated with a respective token. For example, the mapping component 106 may generate a barcode link to an associated token. For reward tokens, users may redeem hard currency with the mapping. In one example, the system 100 may include connections to a distribution system, and the user may present the barcode for scanning. Upon scanning, the distribution system may issue hard currency for the value associated with the token. In an example related to gateway tokens, the mapping (e.g., barcode) may be presented at a retailer to indicate that the customer has a loyalty status that allows them to access an exclusive benefit associated with the loyalty status level, e.g., physical access to a private sale.

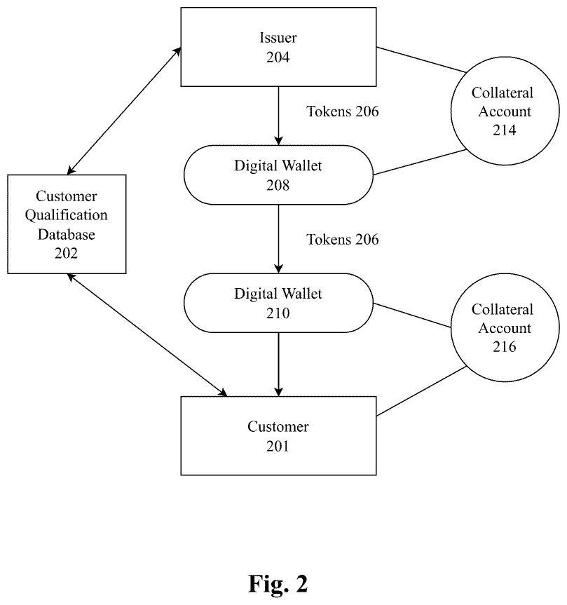

FIG. 2 illustrates the distribution of the cryptocurrency to qualified customers of a customer loyalty program according to various example embodiments. The customers 201 may be vetted for specific qualifications. Again, some specific use cases describing example qualifications will be described in greater detail below. Once qualified, the customers 201 may be stored in a customer qualification database 202 and consumer qualification information may be accessed by the system at any time to ensure that a respective user meets any qualifications for participation. For example, a token issuer 204 may set various requirements on the system.

The issuer 204 may have a digital wallet 208. The issuer 204 may create token(s) 206 that are stored in the issuer digital wallet 208. The token(s) 206 may be transferred by the issuer 204 to a digital wallet 210 of a customer, e.g., customer 201. Each issuer 204 and customer 201 may have respective collateral accounts 214, 216 to meet member requirements or qualifications. In one example, the customer 201 may transfer currency from their collateral account 216 to the collateral account 214 of the issuer 204 for the purposes of purchasing the token(s) 206. Banks, other financial institutions, or redemption centers may interact with the collateral accounts 214, 216 to facilitate hard currency redemption. In some example embodiments, the token(s) 206 may be transferred to the digital wallet 210 of the customer 201 without a corresponding currency transfer, e.g., the token(s) 206 are earned in different manners. For example, to earn gateway tokens, the issuer 204 may track actions of the customer 201, e.g., number of purchases, amount of purchases, physical visits to a store, virtual visits to a website, etc., and award gateway tokens based on the actions. The issuer 204 may set any criteria for earning gateway tokens, including that gateway tokens may be purchased.

Prior to describing the transfer of gateway/reward tokens, some examples of gateway/reward token schemes are described. The example embodiments are not limited to these gateway/reward token schemes but these are merely provided as examples.

In a first example, the functionality of the gateway tokens and the reward tokens may be included in a single token. For example, consider a scenario where 100,000 rewards (e.g., 100,000 reward tokens) qualifies a customer to a gold loyalty status and the corresponding benefits. In this example, the mere fact that a customer has 100,000 reward tokens in their digital wallet indicates the gold loyalty status. This loyalty status may be recorded on the same token as the reward.

In a second example, there may be a one-to-one correspondence between gateway tokens and reward tokens. For example, for each generated reward token, there may be a corresponding gateway token generated. The reward token may be exchanged for specific rewards (e.g., discounts, free flights, etc.) while the gateway token may be used to for the purpose of indicating status. For example, a customer may earn 100,000 reward tokens and the corresponding 100,000 gateway tokens to earn the gold loyalty status. At some time, the customer may exchange some or all of the reward tokens for goods or services. In this scenario, the customer may have less than 100,000 reward tokens but may still have 100,000 gateway tokens indicating that the customer remains at the gold loyalty status even though the customer does not have 100,000 reward tokens.

In this example, after generation, the reward tokens and the gateway tokens may be decoupled, e.g., the reward token and the corresponding gateway token do not have to be in the same digital wallet. This decoupling of reward tokens and corresponding gateway tokens may also apply to other examples. Further, in some example embodiments, the reward tokens and/or gateway tokens may have an expiration date (or time). Continuing with the example started above, if a customer has 100,000 gateway tokens in their digital wallet, these gateway tokens may expire (e.g., after 1, 3, 5 year(s) from original issuance, 1, 3, 5 years from the customer last earning or being transferred other gateway tokens, etc.) so the gateway tokens do not entitle the customer to the gold loyalty status for all time. Such an expiration may be encoded in the blockchain of the gateway token. On the other hand, there is no requirement that gateway tokens and/or reward tokens expire.

In a third example, there may be a one-to-many correspondence between gateway tokens and reward tokens, e.g., one gateway token may correspond to multiple reward tokens (e.g., 100, 1,000, 10,000, etc.). For example, the issuer may generate a gateway token each time a customer earns the threshold number of reward tokens and issue the gateway token to the customer.

In a fourth example, each customer may have a master gateway token that records a customer loyalty status of the customer and that may be updated as various customer actions are performed. For example, the master gateway token may record the number of reward tokens in the customer's digital wallet. In another example, the master gateway token may record the number of reward tokens that are earned or transferred to a customer. This master gateway token may be updated to record a current customer loyalty status.

There may be other gateway/reward token schemes and the example embodiments may be used with any of these gateway/reward token schemes.

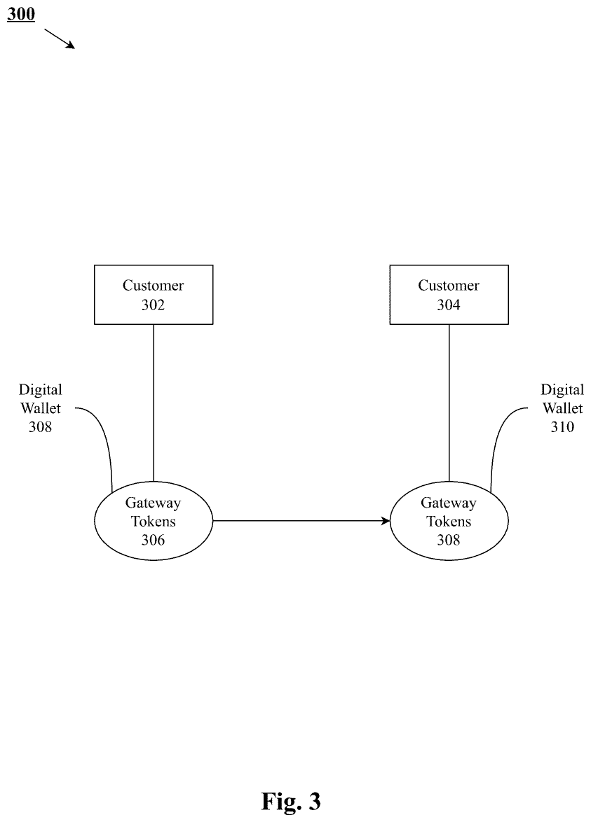

FIG. 3 illustrates a customer-to-customer loyalty status cryptocurrency transfer according to various example embodiments. That is, FIG. 3 is related to the transfer of gateway/reward token(s) between customers. As described above, in some example embodiments, each customer may collect multiple gateway tokens and the number of gateway tokens may represent the loyalty status of the customer. For example, 10 gateway tokens equals silver status, 20 gateway tokens equals gold status, 30 gateway tokens equals platinum status, etc. In other example embodiments, each customer may have a master gateway token that records the customer loyalty status and the master gateway token may be updated as various customer actions are performed.

Each of the gateway token(s) may have an indication of transferability. For example, some gateway tokens may only be used by the user that earned the gateway tokens. Some gateway tokens may be transferable to other users. These transferable gateway tokens are the subject of the exchange of FIG. 3. The indication of transferability may be recorded on the blockchain and, may be used to enforce transferability rules.

In the example of FIG. 3, each customer 302 and 304 has a corresponding digital wallet 308 and 310. The digital wallet 308 of the customer 302 may have one or more gateway tokens 306 associated with the customer loyalty program. The customer 302 may desire to transfer one or more gateway tokens 306 to the customer 304. If the gateway tokens 306 are marked as transferable, the customer 302 may transfer the gateway tokens 306 to the customer 304. If the gateway tokens 306 are not marked as transferable, no transfer may be performed for the tokens. When the gateway tokens 306 are transferred to the customer 304, the information about the customer 302 may be retained in the blockchain of the transferred tokens. This may allow the issuer to determine the user that transferred the tokens when the tokens are redeemed. There may be various types of transfers of the gateway tokens 306 available. The below provides various examples of token transfers. However, there may be other examples of token transfers.

In a first example, the customer 304 may be a verified customer of the customer loyalty program and the transfer of the one or more gateway tokens may be added to any current status that the customer 304 may have already obtained. For example, if the customer 304 was a verified customer but did not have enough gateway token(s) to entitle the customer 304 to a raised loyalty status, the one or more gateway tokens 306 that are transferred to the digital wallet 310 of the customer 304 may be added to any current gateway tokens 308 and used to raise the loyalty status of the customer 304.

In some examples, the transfer of the gateway tokens 306 may cause a loyalty status of the customer 302 to be decreased based on the number of gateway tokens 306 (or amount of loyalty status in the case of a master gateway token) that has been transferred. In other examples, the transfer of the gateway tokens 306 may not decrease the loyalty status of the customer 302. For example, the rules associated with the loyalty status may allow the retailer to keep the customer 302 at the same loyalty status. This may be accomplished by the blockchain not being changed for the remaining gateway token(s) 306 after the transfer, e.g., if the customer 302 had gold status recorded on the blockchain before the transfer, the gold status remains after the transfer. In another example, a rule may be implemented that an equal amount of the gateway tokens 306 that were transferred by the customer 302 are awarded back to the customer 302. A retailer may implement such rules to encourage the customers to freely transfer the gateway tokens to encourage more customers to achieve a loyalty status that increases the purchases/transactions of these newly minted loyalty status customers.

In a second example, the customer 304 may not be a verified customer of the customer loyalty program. In this example, the transfer of the gateway tokens 306 may be accomplished, for example, using the physical representation of the gateway tokens 306 such as the barcode printout example that was described above. In this example, the customer 304 may present this physical representation of the transferred gateway tokens 306 to access the level of the customer loyalty program associated with the status of the transferred gateway tokens 306.

In another example of the customer 304 not being a verified customer of the customer loyalty program, the transfer of the one or more gateway tokens 306 may be held in abeyance until the customer 304 becomes a verified customer of the customer loyalty program. For example, the attempted transfer of the one or more gateway tokens 306 to a non-verified customer may trigger a rule that the attempted transfer is reported to the issuer including information associated with the customer 304, e.g., email address, phone number, etc. This may cause the issuer to contact the customer 304 with information to become a verified customer of the customer loyalty program. If this action is successful, a further rule may be triggered to allow the transfer of the one or more gateway tokens 306 to the customer 304. This, again, may encourage current customers to bring more new customers into the customer loyalty program and the existing customer 302 may be rewarded accordingly, e.g., additional gateway tokens, additional reward tokens, etc.

In another example that may be applied to verified or non-verified customer transfers, the one or more gateway tokens 306 may be specific to a loyalty status for a portion of the customer loyalty program, rather than a general loyalty status. For example, the one or more tokens 306 that are transferred to the digital wallet 310 of the customer 304, may only increase the loyalty status of the customer 304 for a specific purpose, e.g., the one or more gateway tokens 306 do not entitle the customer 304 to all the benefits of the gold status of the customer loyalty program but only one aspect. For example, consider an airline frequent flyer program that entitles a gold loyalty status member to benefits including early boarding, seat upgrades and free baggage. In this example, the one or more gateway tokens 306 may be used to increase the loyalty status of the customer 304 to only access the benefit of early boarding, e.g., when the one or more gateway tokens 306 are transferred to the wallet 310 and become gateway tokens 308 of the customer 304, this limited status may be recorded on the blockchain so that the retailer understands the benefits that should be accorded to the gateway tokens 308. Again, this type of loyalty status transfer may encourage current customers to invite new customers to the loyalty program and then may encourage the new customers to attempt to earn additional status.

Once the customer 304 has the one or more transferred gateway tokens 306, the customer 304 may then use the gateway tokens in the same manner as any other customer that earned the gateway tokens, e.g., to access the reward level associated with the corresponding loyalty status afforded by the transferred gateway tokens 306. The customer 304 may then continue to earn additional gateway tokens based on their interactions with the retailer as was described above.

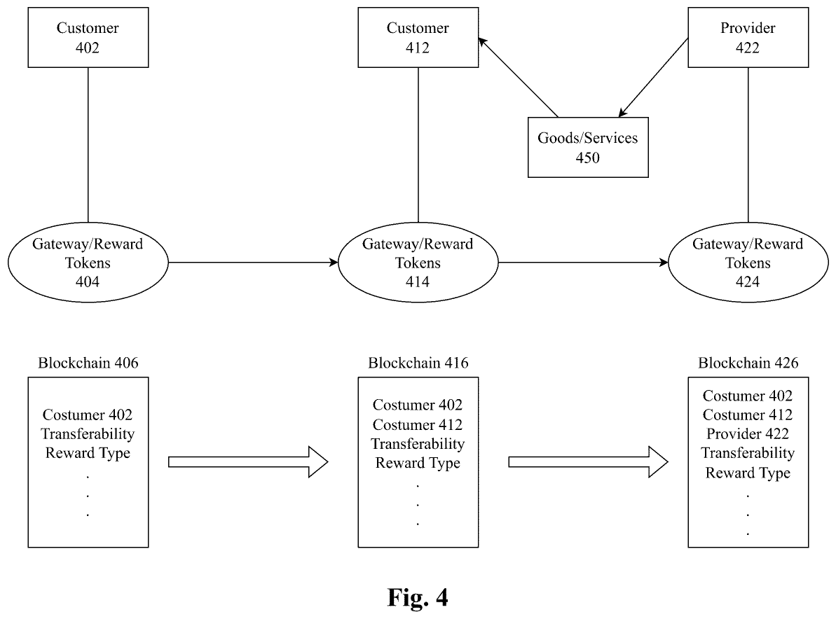

FIG. 4 illustrates a flow chart 400 showing a transfer of the cryptocurrency among customers 402 and 412 and subsequent use to access goods or services 450 from a provider 422 according to various example embodiments. In the example of FIG. 4, the customer 402 may be the original customer that earned the cryptocurrency (e.g., gateway/reward tokens 404) or may be a customer that had the cryptocurrency transferred to them. In some example embodiments, the gateway/reward tokens 404 may only be transferred a limited number of times, e.g., 1, 2, 3, etc. In other example embodiments, the gateway/reward tokens 404 may be transferred an unlimited number of times. This restriction on the number of transfers may be enforced via, for example, the transferability information in the blockchain. An example of this is described in greater detail below.

Also, in this example, the provider 422 of goods or services 450 may be the issuer of the cryptocurrency or, in some examples, the issuer may be a third party that is an administrator of the customer loyalty program for the provider 422. Further, the example of FIG. 4 shows a transfer and subsequent use of gateway/reward tokens. The transfer and subsequent use of the gateway/reward tokens may apply to only gateway tokens, to only reward tokens or to both gateway and reward tokens. Thus, any reference to gateway/reward tokens may refer to one or both of the tokens and, as described above, in some example embodiments, the functionality of the gateway/reward tokens may be embodied in one cryptocurrency token.

Thus, at a first time, the customer 402 may have gateway/reward tokens 404 in their digital wallet. The customer 402 may have a certain loyalty status associated with the gateway token(s) 404. The blockchain 406 shows an example of information that may be stored on the blockchain. It should be understood that this is only a representation of the information and an actual blockchain is cryptographically sealed such that the information stored thereon is immutable (e.g., cannot be changed or altered). In addition, the information shown in FIG. 4 is only an example and other types of information may also be stored in the blockchain.

In the example of FIG. 4, the information on the blockchain 406 may include an identification of the customer 402 (e.g., account number, email, phone number, etc.), an indication of the transferability of the gateway/reward tokens 404 and a reward type associated with the token. For example, the transferability indication may indicate whether the gateway/reward tokens 404 may be transferred and as described above, may or may not have a restriction on the number of times the gateway/reward tokens 404 may be transferred. The reward type may indicate a level of loyalty status that the customer 402 has attained (e.g., silver, gold, platinum), may indicate a specific list of goods or services that the token allows the customer to access (e.g., items on an exclusive list A, items on an exclusive list B, etc.), may indicate a level of discount available to the customer 402 (e.g., 10%, 20%, 30%, etc.) or any other type of reward that the gateway/reward tokens 404 provide to the customer 402.

The customer 402 may desire to transfer the gateway/reward tokens 404 to the customer 412. In a first instance, the example embodiments may enforce transferability rules based on the transferability indication in the blockchain 406 associated with the gateway/reward tokens 404. For example, if the transferability indication in the blockchain 406 indicates that the gateway/reward tokens 404 are not transferable, then the customer 402 may not perform a transfer of the gateway/reward tokens 404. In this example, it may be considered that the gateway/reward tokens 404 are transferable.

Thus, the customer 402 transfers the gateway/reward tokens 404 to the wallet of the customer 412 and these transferred tokens are now represented as gateway/reward tokens 414 in the wallet of the customer 412. Various examples of transfers were described above and the transfer in the example of FIG. 4 may be any of the above described transfers or any other type of transfer. The gateway/reward tokens 414 shown in FIG. 4 refer to the tokens that were transferred. In some scenarios, the customer 412 may have other gateway/reward tokens associated with the provider 422 already in their wallet and the gateway/reward tokens 414 may be added to these other gateway/reward tokens. However, there is no requirement that the customer 412 have other gateway/reward tokens associated with the provider 422 in their digital wallet.

As shown in FIG. 4, when the gateway/reward tokens 414 are transferred additional information may be stored on the blockchain 416 associated with the gateway/reward tokens 414. In this example, the additional information may be the identity of the customer 414 that currently holds the gateway/reward tokens 414. Other information may also be added as a result of the transfer but is not shown in the figure. However, as shown in FIG. 4, the blockchain 416 may retain the information that was originally in the blockchain 406, e.g., the identity of the customer 402, the transferability indication and the reward type indication.

As described above, in some example embodiments, the transferability of the gateway/reward tokens may be unlimited and thus, the transferability indication may be retained as is. In other example embodiments, the gateway/reward tokens may only be transferred a predetermined number of times. Thus, the blockchain 416 may record the number of transfers (e.g., 1, 2, 3, etc.) that have occurred for the gateway/reward tokens 414. When the limit has been reached a new transferability indication may be added to the blockchain indicating that the gateway/reward tokens are no longer transferable. There may be other methods of recording the number of transfers, e.g., incrementing a counter, decrementing a counter, etc.

In any case, once the customer 412 has the gateway/reward tokens 414, the customer 412 may then attempt to use the gateway/reward tokens 414 to access benefits associated with the customer loyalty status of the gateway tokens and/or redeem goods or services using the reward tokens. As described above, the addition of the gateway/reward tokens 414 to the wallet of the customer 412 may entitle the customer 412 to rewards/access to goods/services or other reward types that the customer 412 has not earned on their own.

In this example embodiment, the customer 412 holding the gateway/reward tokens 414 may transfer one or more gateway/reward tokens 414 from their digital wallet to a digital wallet of the good or services provider 422. These transferred tokens are now represented as gateway/reward tokens 424 in the wallet of the provider 422. In this example, the one or more gateway tokens 424 may be associated with a specific loyalty status that entitles the customer 412 to certain benefits associated with the corresponding loyalty status. When the goods or services provider 422 receives the one or more gateway tokens 424, the provider 422 may verify that the one or more tokens 424 entitle the customer 412 to the level of loyalty status. However, as described above, the only verification that may be used is the possession of the tokens. No other interaction between the customer 412 and the provider 422 may be required. For example, if the gateway tokens 424 are transferable and if customer 412 has possession of the gateway tokens, the customer 412 may be entitled to the benefits of the status associated with the gateway tokens.

If the customer 412 is a user to which the one or more gateway tokens 424 have been transferred (e.g., the scenario shown and described with reference to FIG. 4), the provider 422 may verify that the one or more gateway tokens 424 are transferable. As described above, in some example embodiments, the blockchain 426 associated with the one or more gateway tokens 424 may have an indication of transferability. The provider 422 may verify that the one or more gateway tokens 424 are transferable based on the transferability indication, e.g., if the transferability indication indicates unlimited transferability or if the limited number of transfers have not been exceeded. In other example embodiments, the provider 422 may implement a rules based verification where the one or more gateway tokens 424 are identified (e.g., based on a token ID or any other type of identifying characteristic) and a rule corresponding to the identification may be invoked, e.g., gateway tokens having IDs in the range of XXXX-YYYY are transferable, gateway tokens having IDs in the range of AAAA-BBBB are not transferable, etc. Thus, the provider 422 may verify that the one or more gateway tokens 424 are transferable to the customer 412.

As described above, in some example embodiments, the provider 422 may use the identity information of the customer 412 that is stored on the blockchain 426 to verify that the customer 412 is a verified customer or that the customer 412 has a valid account with the provider 422. However, such a verification is not a requirement of the example embodiments.

As shown in FIG. 4, the blockchain 426 of the one or more gateway tokens 424 may retain the information of the customer 402 from which the one or more gateway tokens 424 were transferred. The provider 422 may use this information for various purposes, e.g., the provider 422 may provide additional benefits to customers that have transferred status to a new customer, etc.

Once the provider 422 validates the one or more gateway tokens 424, the provider 422 may then indicate to the customer 412 the benefits associated with the level of loyalty status. The customer 412 may then transfer reward tokens to the goods and services provider 422 to purchase/select the goods or services 450 that are available to the customer 412 based on the loyalty status. As described above, in some example embodiments, the transferred gateway/reward tokens may be combined with existing gateway/reward tokens that are already in the digital wallet of the customer 412 for status/reward computations.

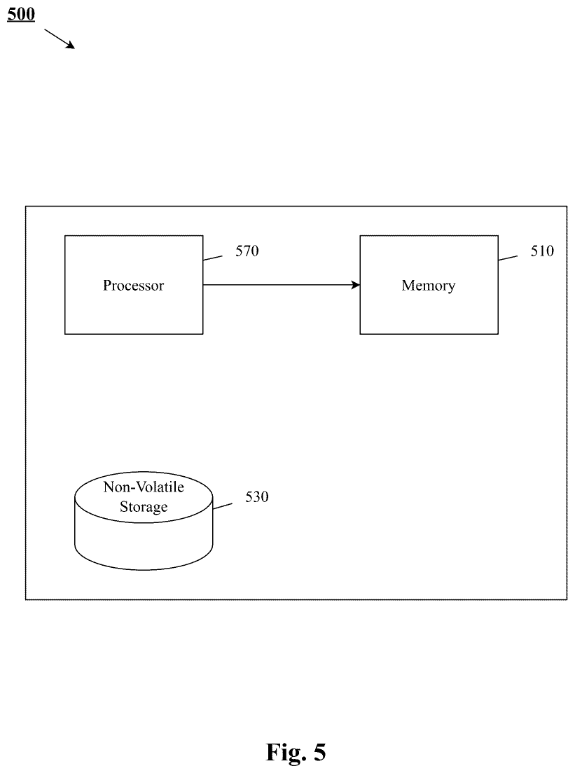

FIG. 5 shows an illustrative implementation of a computer system 500 that may be used in connection with any of the embodiments of the disclosure provided herein. The computer system 500 may include one or more processors 510 and one or more articles of manufacture that comprise non-transitory computer-readable storage media (e.g., memory 520 and one or more non-volatile storage media 530). The processor 510 may control writing data to and reading data from the memory 520 and the non-volatile storage device 530 in any suitable manner. To perform any of the functionality described herein, the processor 510 may execute one or more processor-executable instructions stored in one or more non-transitory computer-readable storage media (e.g., the memory 520), which may serve as non-transitory computer-readable storage media storing processor-executable instructions for execution by the processor 510.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

What is claimed:

1. A system, comprising:
a memory; and
a processor communicatively coupled to the memory and configured to:
receive, from a first user, a digital currency unit comprising an indication of a loyalty status associated with the digital currency unit, wherein the digital currency unit is associated with one or more blocks of a distributed ledger, wherein the one or more blocks record the indication of the loyalty status and a transferability indication corresponding to the digital currency unit;
determine the digital currency unit was transferred to the first user from a second user; and
verify, based on information recorded on the one or more blocks, that the digital currency unit is transferable;
in response to verifying the digital currency unit is transferable, send a response to the first user including the indication of the loyalty status associated with the digital currency unit.

2. The system of claim 1, wherein the processor is further configured to:
verify, based on information recorded on the one or more blocks, that the first user is a validated user.

3. The system of claim 2, wherein sending the response is further based on verifying the first user is the validated user.

4. The system of claim 2, wherein, when the first user is not the validated user, the processor is further configured to:
send a request to the first user to become a validated user, wherein sending the response is delayed until the first ser becomes a validated user.

5. The system of claim 1, wherein verifying the digital currency unit is transferable is based on the transferability indication.

6. The system of claim 1, wherein the information recorded on the one or more blocks comprises an identification of the digital currency unit, wherein verifying the digital currency unit is transferable is based on comparing the identification to one or more rules.

7. The system of claim 1, wherein the information recorded on the one or more blocks comprises an identification of the second user.

8. The system of claim 1, wherein the processor is further configured to:
generate the digital currency unit comprising the indication of the loyalty status.

9. The system of claim 1, wherein the loyalty status corresponds to an offer for the first user.

10. The system of claim 9, wherein the offer comprises one of a type of goods available to the first user or a discount offered to the first user.

11. The system of claim 1, wherein the digital currency unit is related to a customer loyalty program and comprises a gateway token that controls access to benefits related to the customer loyalty status for the customer loyalty program and wherein further digital currency units related to the customer loyalty program comprise reward tokens that are redeemed for rewards from the customer loyalty program.

12. The system of claim 11, wherein the rewards are associated with the customer loyalty status.

13. The system of claim 1, wherein information recorded on the one or more blocks comprises a transferability rule limiting a number of transfers for the digital currency unit.

14. The system of claim 1, wherein information recorded on the one or more blocks comprises an indication of a user that first earned the digital currency unit and each user to which the digital currency unit has been transferred.

15. A system, comprising:
a memory; and
a processor communicatively coupled to the memory and configured to:
receive, from a first user, a digital currency unit comprising an indication of a loyalty status associated with the digital currency unit, wherein the digital currency unit is associated with one or more blocks of a distributed ledger, wherein the one or more blocks record the indication of the loyalty status corresponding to the digital currency unit and a transferability indication or an identification of the digital currency unit;
store the digital currency unit in a digital wallet corresponding to a second user;
send, to a provider, the digital currency unit; and
receive, from the provider, a response including an indication of benefits associated with the loyalty status of the digital currency unit.

16. The system of claim 15, wherein the information recorded on the one or more blocks comprises an identification of the first user.

17. The system of claim 15, wherein the information recorded on the one or more blocks comprises an identification of the second user.

18. The system of claim 15, wherein the benefits comprise one of a type of goods available to the second user or a discount offered to the second user.

19. The system of claim 15, wherein the digital currency unit is added to other digital currency units in the digital wallet of the second user to increase the loyalty status of the second user.

20. The system of claim 15, wherein the processor is further configured to:
receive, from the provider in response to sending the digital currency unit, a request to become a validated user prior to receiving the indication of the benefits.
